(19) United States
(12) Patent Application Publication
(10) Pub. No.: US 2004/0019742 A1
(43) Pub. Date: Jan. 29, 2004

(54) Portable data storage device

(76) Inventors: Te-Chang Wei, Taipei (TW); Ting-Chang Kuo, Taipei (TW); Chun-Yu Chen, Taipei (TW)

Correspondence Address: BIRCH STEWART KOLASCH & BIRCH, PO BOX 747, FALLS CHURCH, VA, 22040-0747, US

(21) Appl. No.: 10/282,032

(22) Filed: Oct. 29, 2002

(30) Foreign Application Priority Data
Jul. 26, 2002 (TW) 91211532

(51) Int. Cl. G06F 12/00

(52) U.S. Cl. 711/115

(57) ABSTRACT

A portable data storage device is provided, comprising memory, a first data transmission interface and at least a second data transmission interface. The first data transmission interface provides connection of the portable data storage device to an electronic device. Meanwhile the second data transmission device, having the same interface as the first data transmission interface, provides further connection of other devices to the electronic device through internal connection between the first and the second transmission interfaces.

### BACKGROUND OF THE INVENTION

1. Field of the Invention

The invention generally relates to a portable data storage device for data storage and transmission, and particularly relates to a portable data storage device that includes more than one data transmission interface for connections to other devices.

2. Related Art

Hard disks are common data storage devices for storing data for computers. They have advantages of higher capacities than floppy disks. The capacities of hard disks are increasing from several megabytes at prior time to tens of gigabytes at present time. The size of a hard disk is somehow large that requires fixed installation in the computer and is suitable for storing database and applications of the computer. When there is need for the user to carry or transfer data from the computer, other storage media, such as floppy disks have to be used. However, the floppy disk is limited with small storage capacity of only 1.44 megabytes that does not afford a larger file. Therefore, when carrying a large image or drawing file, the user has to segment the file into several portions in order to store them with several floppy disks. Though there have been Zip drives that can store more data, they are not commonly accepted by user since the Zip drives are only accessible through a Zip driver that is costly and is not commonly used by people. There are also recordable optical disks, such as CD-R, available for higher capacity storage. However, they require CD writers and readers to write and to read the disks and encounter the same limitations as the Zip drives do.

Some portable data storage devices have been developed to meet user's requirements. The portable data storage devices are incorporated with memory units of 16 or 32 megabytes, and transmission interfaces. Via the transmission interfaces, the memory units are connected with other electronic devices for data reading and writing. The portable data storage devices are compact and convenient that they can store a great amount of application software, backup data or specific files, such as animation, images, video or audio information.

FIG. 1 shows a portable data storage device 11 of prior arts. The data storage device 11 includes a main body 111 having a memory 112 connected through a universal serial bus (USB), e.g., a male connector 113 as shown, to a computer for data transmission. The USB supports plug and play and multiple stream functions, and capable of transferring data in a baud rate of 1.5 million bytes per second. Therefore, the data storage device 11 becomes a convenient tool for user to store data, carry it anywhere and transfer data with computers.

FIG. 2 shows an application example of the data storage device 11 in which the device is connected to a notebook computer 21. Generally, the notebook computer 21 includes two USB female ports 211 and 212 at the back. Upon data transmission, the male connector 113 of the data storage device 11 is plugged into a female port 211 of the computer. The USB supports hot connection so that the computer can access data right after the connection, and data can be transmitted from the computer to the data storage device 11 or from the data storage device 11 to the computer.

As there are fixed capacity of memory 112 in the data storage device 11, the user has to use another data storage device if the first data storage device 11 is insufficient. In that case, both USB female ports 211 and 212 are occupied. Then, it is impossible for other peripheral devices, such as mouse, scanner, printer or digital camera, to link to the computer further. Though it is possible to let the computer incorporated with more USB ports, it is not a preferable method.

### SUMMARY OF THE INVENTION

The object of the invention is to provide a portable data storage device that includes at least a second transmission interface.

A portable data storage device according to the invention includes a main body having a memory, a universal serial bus male connector and a universal serial bus female port. When the data storage device is connected to a computer thorough the male connector, the female port is provided for other electronic device connecting through to the computer without using up the original interface ports of the computer.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a structural diagram of a conventional portable data storage device;

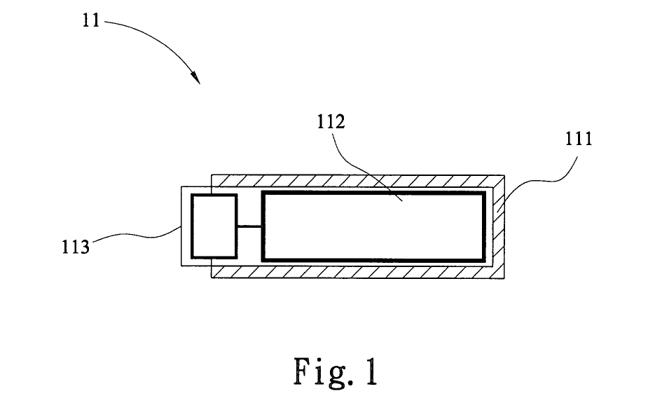

FIG. 2 is an application example of the conventional portable data storage device of FIG. 1;

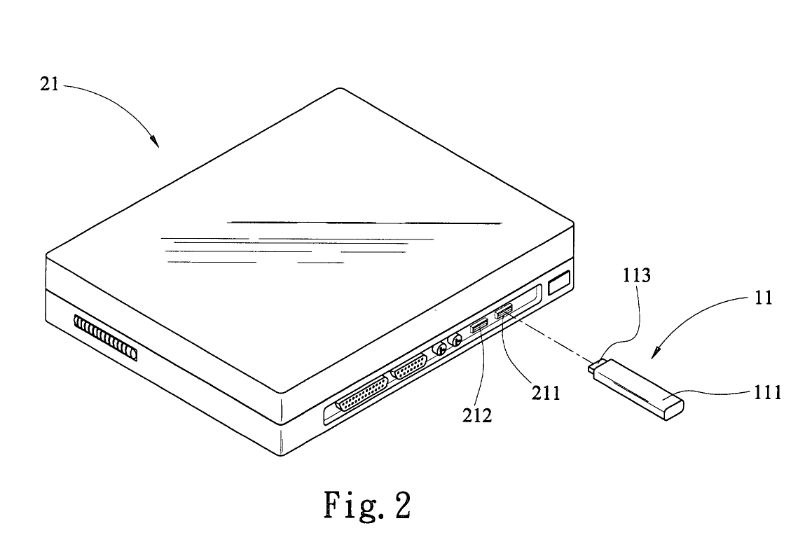

FIG. 3 is a structural diagram of a portable data storage device as first embodiment of the invention;

FIG. 4 is a perspective view of the first embodiment of the invention;

FIG. 5 is an application example of the first embodiment of the invention;

FIG. 6 is a structural diagram of a portable data storage device as second embodiment of the invention;

FIG. 7 is a perspective view of the second embodiment of the invention;

FIG. 8 is a first application example of the second embodiment of the invention; and

FIG. 9 is a second application example of the second embodiment of the invention.

### DETAILED DESCRIPTION OF THE INVENTION

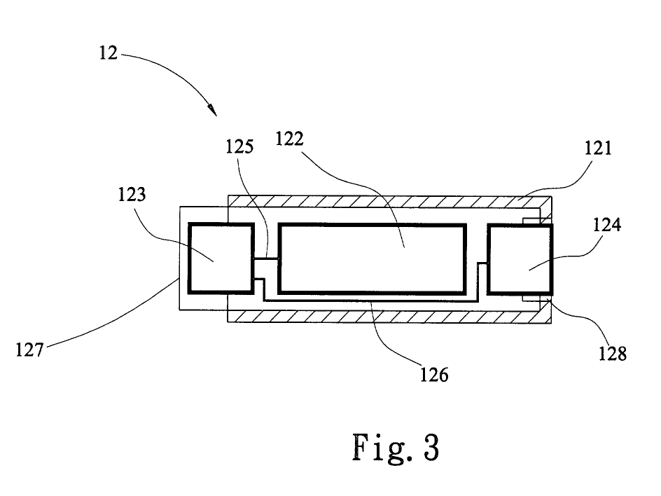

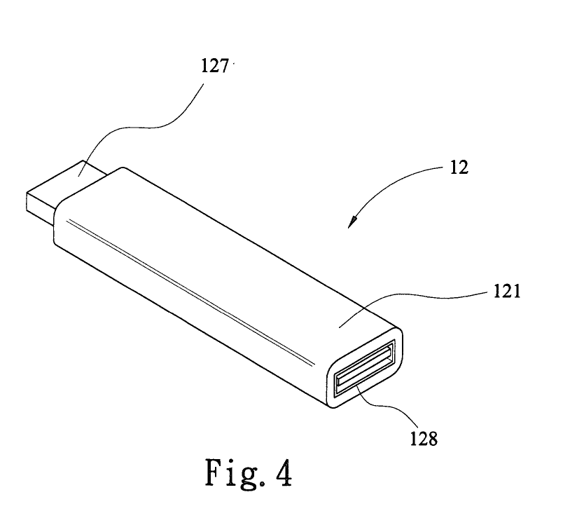

Now referring to FIG. 3, a portable data storage device 12 as first embodiment of the invention includes a main body 121 having a memory 122 mounted therein. A first data transmission interface 123 is connected to the memory 122 through connecting wires 125. The first data transmission interface 123 is a USB male connector 127. Other connecting wires 126 further connect the first transmission interface 123 to a second data transmission interface 124. The second data transmission interface 124 is a USB female port 128. In other words, there are two data transmission interfaces 123 and 124 in the main body 121. FIG. 4 is a perspective view of the portable data storage device 12 of the first embodiment showing the main body 121 having the USB male connector 127 at one end and the USB female port 128 at the other end.

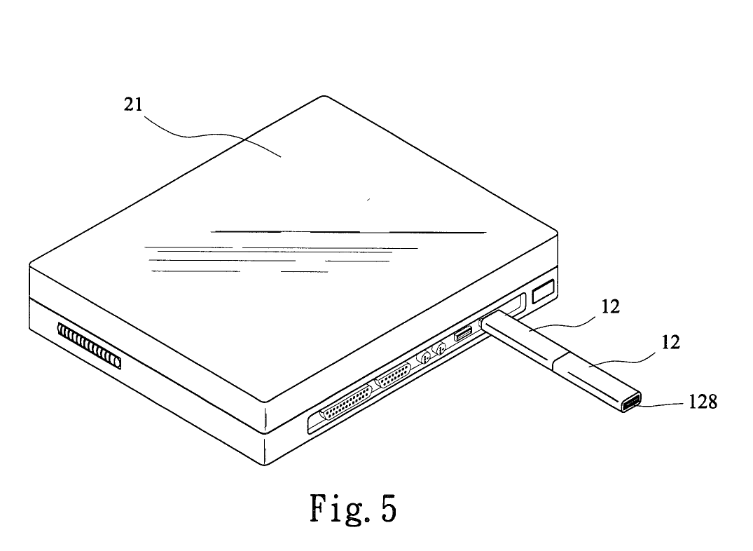

FIG. 5 is an application example of the first embodiment of the invention. The portable data storage device 12 is connected to a notebook computer 21. The USB female port 128 at the rear end is ready for another portable data storage device 12 or other electronic device to plug in. Since the USB is capable of hot connection, it can be plugged and unplugged anytime for use. When serially connecting several portable data storage devices 12 of the invention, the USB female port 128 of the last one is always ready for another device to connect. Thus the number of USB ports of the computer is remained.

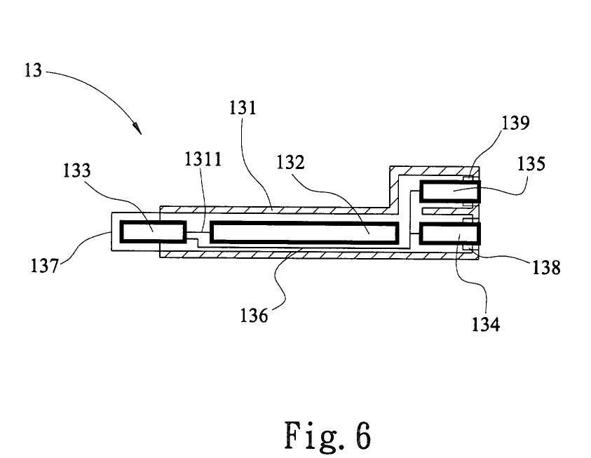

FIG. 6 is a structural diagram of a second embodiment of the invention. The portable data storage device 13 includes a main body 131 having a memory 132 mounted therein. A first data transmission interface 133 is connected to the memory 132 through connecting wires 1311-1331. The first data transmission interface 133 is a USB male connector 137. Other connecting wires 1332-1341-1351 further connect the first transmission interface 133 to a second data transmission interface 134 and a third data transmission interface 135. The second and third data transmission interfaces 134, 135 are USB female ports 138, 139. In other words, there are three data transmission interfaces 133, 134 and 135 in the main body 131.

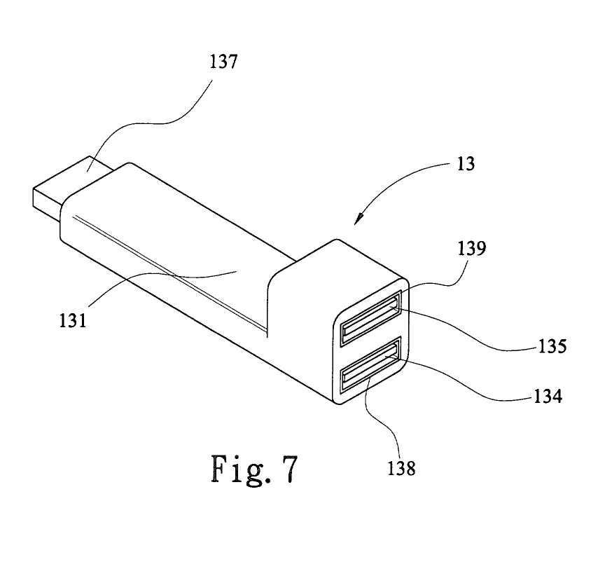

FIG. 7 is a perspective view of the portable data storage device 13 of the second embodiment showing the main body 131 having the USB male connector 137 at one end and the USB female ports 138, 139 at the other end. The USB female ports 138, 139 relate to the second and the third data transmission interfaces 134, 135 respectively.

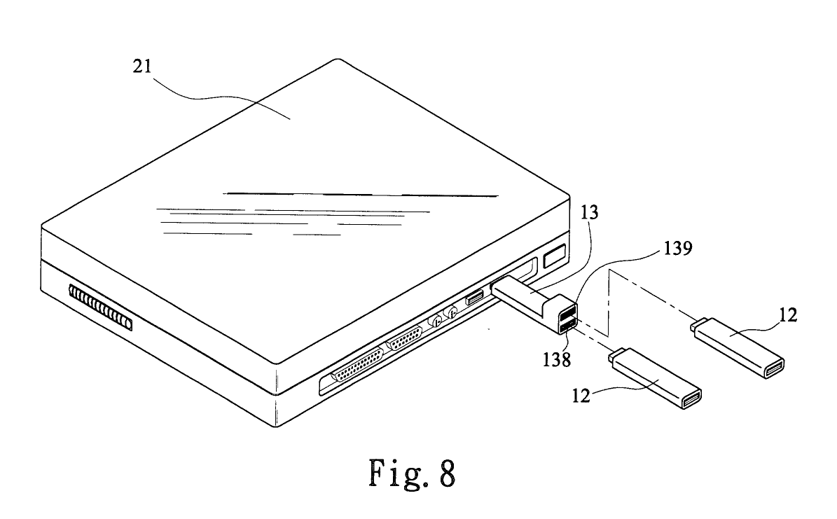

FIG. 8 is a first application example of the second embodiment of the invention. The portable data transmission device 13 is connected to a notebook computer through the USB male connector at the front end. Then the USB female ports 138, 139 of the back end are left for further connection to other devices, such as other portable data transmission devices 12, and still remains USB female ports at the back ends.

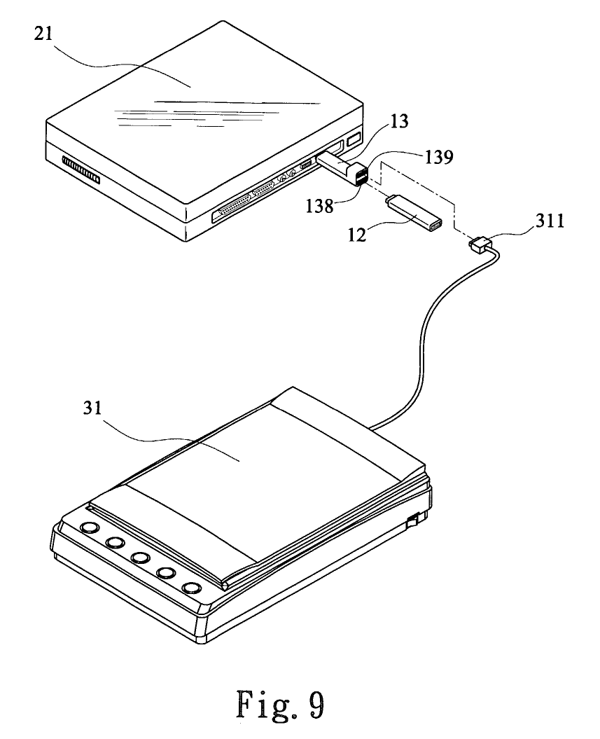

FIG. 9 is a second application example of the second embodiment of the invention. The portable data transmission device 13 is connected to a notebook computer through the USB male connector at the front end. Then the USB female ports 138, 139 of the back end are left for further connection to other devices, such as another portable data transmission device 12 and a scanner 31, via male connectors 311, respectively. The portable data transmission device 12 reserves a USB female port at the back end for further connection of another device.

In the embodiments of the invention, the data transmission interface in the main body can conform to any standard of a Small Computer System Interface (SCSI), Personal Computer Memory Card Association (PCMCIA), Institute of Electrical and Electronics Engineers 1394 (IEEE 1394) and so on. The electronic device or data processing device that the portable data transmission device connects with can be any notebook computer, desktop computer, personal digital assistant, digital camera or the like.

As described above, the portable data transmission device at least has the following advantage:

a) Allowing serial connection of several storage devices;

b) Never use up the USB port of the device where it connects; and

c) Allowing serial connection of other storage or peripheral devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable data storage device for selectively connecting to an electronic data processing device and transferring data between the two, comprising:
a memory for storing data;
a first data transmission interface, electrically connected among said memory and said data processing device; and
a second data transmission interface, electrically connected to said first transmission interface, and having a same interface as said first data transmission interface, for connection to said data processing device through said first data transmission interface.

2. A portable data storage device according to claim 1 comprises at least two data transmission interfaces of the same.

3. A portable data storage device according to claim 1 wherein said electronic data processing device is a computer.

4. A portable data storage device according to claim 1 wherein said electronic data processing device is a notebook computer.

5. A portable data storage device according to claim 1 wherein said electronic data processing device is a personal digital assistant.

6. A portable data storage device according to claim 1 wherein said electronic data processing device is a digital camera.

7. A portable data storage device according to claim 1 wherein said first and said second data transmission interfaces are universal serial buses (USB).

8. A portable data storage device according to claim 1 wherein said first and said second data transmission interfaces conform to standard of Institute of Electrical and Electronics Engineers 1394.

9. A portable data storage device according to claim 1 wherein said first and said second data transmission interfaces conform to standard of Personal Computer Memory Card International Association.

10. A portable data storage device according to claim 2 wherein said data transmission interfaces are universal serial buses.

11. A portable data storage device according to claim 2 wherein said data transmission interfaces conform to standard of Institute of Electrical and Electronics Engineers 1394.

12. A portable data storage device according to claim 2 wherein said data transmission interfaces conform to standard of Personal Computer Memory Card International Association.

13. A portable data storage device according to claim 1 further comprises a third data transmission interface.

14. A portable data storage device according to claim 14 wherein said third data transmission interface is a universal serial bus.

15. A portable data storage device according to claim 14 wherein said third data transmission interface conforms to standard of Institute of Electrical and Electronics Engineers 1394.

16. A portable data storage device according to claim 14 wherein said third data transmission interface conforms to standard of Personal Computer Memory Card International Association.
